(19) United States
(12) Patent Application Publication
(10) Pub. No.: US 2011/0316954 A1
(43) Pub. Date: Dec. 29, 2011

(54) ELECTRIC POWER CONTROL APPARATUS, ELECTRONIC MACHINE AND ELECTRIC POWER CONTROL METHOD

(75) Inventor: Tadahiro Komatsu, Shizuoka (JP)

(73) Assignee: TOSHIBA TEC KABUSHIKI KAISHA, Tokyo (JP)

(21) Appl. No.: 13/027,374

(22) Filed: Feb. 15, 2011

(30) Foreign Application Priority Data
Jun. 23, 2010 (JP) 2010-142580

(51) Int. Cl. B41J 2/32; H02J 7/04

(52) U.S. Cl. 347/171; 320/162

(57) ABSTRACT

According to certain embodiments, a power control apparatus may include a setting unit, a voltage detection unit, and a control unit. The setting unit may be configured to set a charge start voltage and a charge stop voltage for a storage battery. The voltage detection unit may be configured to detect an output voltage of the storage battery. The control unit, upon being powered from an external power source, may be configured to control the charge operation of the storage battery based on a current charge state of the storage battery. The current charge state of the storage battery may be determined by comparing the detected output voltage of the storage battery with the charge start voltage and the charge stop voltage.

### CROSS-REFERENCE TO RELATED APPLICATIONS

This application is based upon and claims the benefit of priority from Japanese Patent Application No. 2010-142580, filed on Jun. 23, 2010, the entire contents of which are incorporated herein by reference.

### FIELD

Embodiments described herein relate generally to an electric power control apparatus, an electronic machine, and an electric power control method.

### BACKGROUND

In general, a storage battery may be mounted in a hand-held electronic machine to be used as an internal power source therein. Such storage battery may be repetitively recharged and discharged within a predetermined number of charge-discharge cycles.

When an electronic machine with a storage battery is connected to an external power source through an adapter, if the storage battery is not in a fully-charged state, a charge circuit of the electronic machine commences and continues a recharge operation until the storage battery reaches a fully-charged state.

Such storage batteries, however, have inherent characteristics (hereinafter referred to as “capacity degradation”) in which the discharge capacity gradually decreases as the number of performing charge operations increases or as the time remaining in a fully-charged state increases.

For example, if a storage battery in a fully-charged state is kept in a high temperature environment such as the inside of a vehicle for a long time, it may cause a significant capacity degradation of the storage battery.

As described above, the storage battery may commence the charge operation unconditionally upon an external power source being connected thereto, unless the storage batter is in a fully-charged state. This may unnecessarily increase the number of charge operations performed on the storage battery. In addition, the storage battery may be unnecessarily charged and kept in a fully-charged state for a long time, which causes capacity degradation and shortens the life of the storage battery.

### BRIEF DESCRIPTION OF THE DRAWINGS

FIG. 1 is a perspective view showing a portable printer.

FIG. 2 is a block diagram showing a hardware configuration of a main body housing of the portable printer.

FIGS. 3A to 3C are diagrams showing an example of a charge voltage setting screen displayed on a display block.

FIG. 4 is a block diagram showing a detailed configuration of a power control apparatus.

FIG. 5 is a block diagram showing a functional configuration of the portable printer.

FIG. 6 is a block diagram showing a functional configuration of a control circuit.

FIG. 7 is a flow chart showing procedures of setting a charge start voltage and a charge stop voltage to be executed in the portable printer.

FIG. 8 is a flow chart showing procedures for controlling a charge operation to be executed in the portable printer.

### DETAILED DESCRIPTION

According to one embodiment, a power control apparatus includes a setting unit, a voltage detection unit, and a control unit. The setting unit is configured to set a charge start voltage and a charge stop voltage for the storage battery. The voltage detection unit is configured to detect an output voltage of the storage battery. The control unit is configured to control a charge operation of the storage battery based on a current charge state of the storage battery. The current charge state of the storage battery is determined by comparing the output voltage of the storage battery detected by the voltage detection unit with the charge start voltage and the charge stop voltage set by the setting unit.

According to another embodiment, an electric power control method is provided. The method includes setting a charge start voltage and a charge stop voltage for the storage battery, detecting an output voltage of the storage battery, and controlling the charge operation of the storage battery based on a current charge state of the storage battery. The current charge state of the storage battery is determined by comparing the detected output voltage of the storage battery with the charge start voltage and the charge stop voltage.

Hereinafter, embodiments are described with reference to the accompanying drawings.

A hand-held label printer is described below as an electronic machine according to one embodiment. The hand-held label printer (hereinafter, referred to as a portable printer) may be used by a delivery person when delivering goods or products from a vehicle such as a delivery van. Once the goods or products are delivered, the delivery person can print information on a label using the portable printer in association with the goods or products.

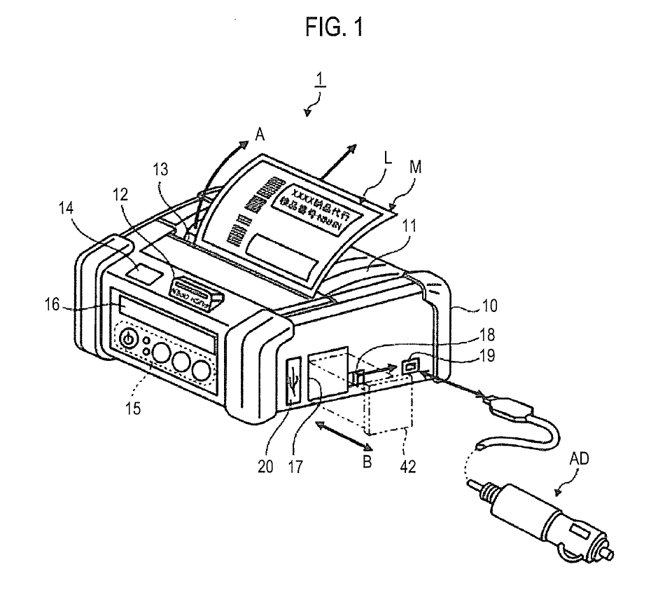

Referring to FIG. 1, there is shown a perspective view of a portable printer 1 in accordance with the present embodiment.

As shown in FIG. 1, the portable printer 1 includes a main body housing 10. A cover 11, an open button 12, a label issuing outlet 13, and a communication window 14 are arranged on an upper side of the main body housing 10. The cover 11 is configured to cover a paper roll contained in a containing cavity (not shown) installed in the main body housing 10. The open button 12 is configured to open the cover 11 in a fanwise direction A. The label issuing outlet 13 is configured to issue a label L bearing information printed thereon and having a backing sheet M adhered thereto. The label issuing outlet 13 is configured to output the label L from which the backing sheet M is stripped. The communication window 14 is configured to display reception/transmission of wireless communication data in compliance with a wireless infrared communication standard, for example, IrDA (Infrared Data Association).

The paper roll includes, for example, a label paper roll with a plurality of the labels L adhered to the backing sheet M. Each label L has a printing surface on its front side and an adhesive surface on its rear side. The labels L is adhered in a row to the backing sheet M, which is wound around a paper core, thereby forming the label paper roll.

A keyboard 15 and a display 16 are arranged on the front of the main body housing 10 to be used as user interfaces.

The keyboard 15 includes push buttons that may be pressed by a user. The push buttons include a power button for turning the power on and off, a sheet feed button for activating sheet feeding, a pause button for pausing sheet feeding, and a mode selection button for activating a charge mode setting. As described later in the present disclosure, the charge mode setting is used to select a charge mode for setting a charge voltage value.

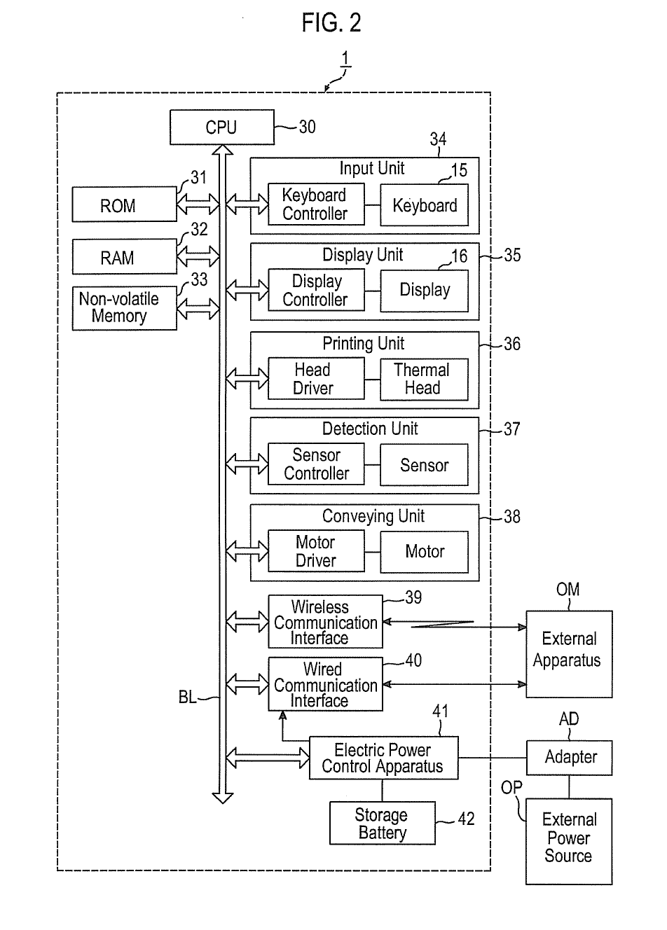

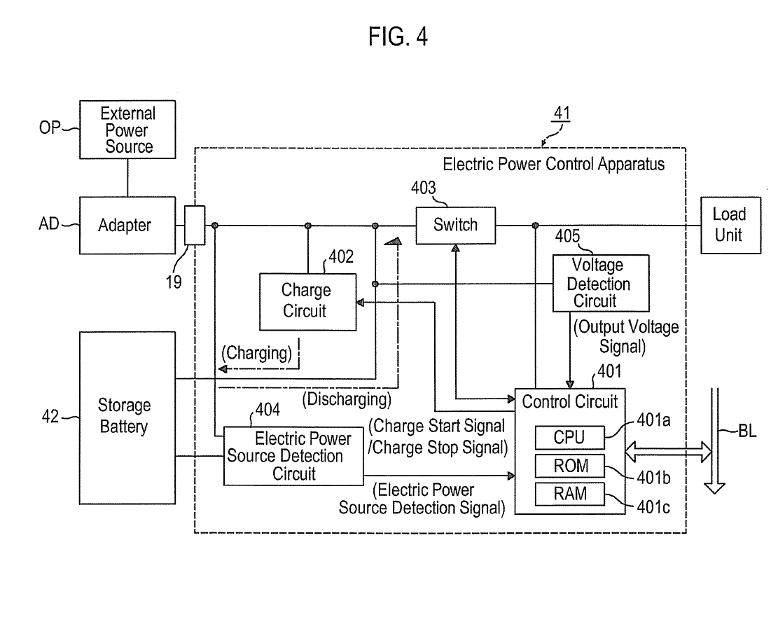

On a lateral side of the main body housing 10, a battery accommodation cavity 17, an ejection lever 18, an adapter terminal 19, and a cable terminal 20 are arranged. The battery accommodation cavity 17 is configured to accommodate a storage battery 42 which is detachable from the main body housing 10 and a connection portion (to be connected to an electric power control apparatus 41, which will be described later) in the direction of a bidirectional arrow B. The ejection lever 18 is configured to eject the storage battery 42 from the battery accommodation cavity 17. The adapter terminal 19 is configured to connect to an adapter AD, including a cigarette lighter adapter, to be coupled to an external power source OP (See FIGS. 2 and 4), for example, a household electric power outlet or a car cigarette lighter of a vehicle. The cable terminal 20 is configured to connect to a cable including a universal serial bus (USB) cable to be coupled to an external apparatus OM (See FIG. 2), for example, a personal computer.

A containing cavity, a platen roller (not shown), and a thermal head (See FIG. 2) are arranged within the main body housing 10. The containing cavity is configured to contain a paper roll. The platen roller may be rotated by a motor (See FIG. 2) to withdraw a leading-end of the label L attached to the backing sheet M from the paper roll contained in the containing cavity and then convey the label L in a conveying direction, i.e., toward the label issuing outlet 13. The thermal head is configured to print information on the print surface of the label L attached to the backing sheet M while it is interposed between the platen roller and the thermal head during conveyance.

Referring to FIG. 2, a block diagram of a hardware configuration of the main body housing 10 of the portable printer 1 in accordance with one embodiment is shown.

As shown in FIG. 2, the portable printer 1 includes a central processing unit (CPU) 30 and components connected to the CPU 30 through a bus line BL. The components, for example, include a read only memory (ROM) 31, a random access memory (RAM) 32, a non-volatile memory 33, an input unit 34, a display unit 35, a printing unit 36, a detection unit 37, a conveying unit 38, a wireless communication interface 39, and a wired communication interface 40. The portable printer 1 further includes the electric power control apparatus 41 and the storage battery 42 in order to supply electric power to the CPU 30 and the respective components.

The CPU 30 may deploy a program stored in the ROM 31 to the RAM 32 and execute the program to control the entire operation of the portable printer 1.

The ROM 31 may store programs and data files of data to be used in executing the programs. The RAM 32 may temporarily store data being produced and processed upon execution of the programs. The non-volatile memory 33 may store print data received from the external apparatus OM.

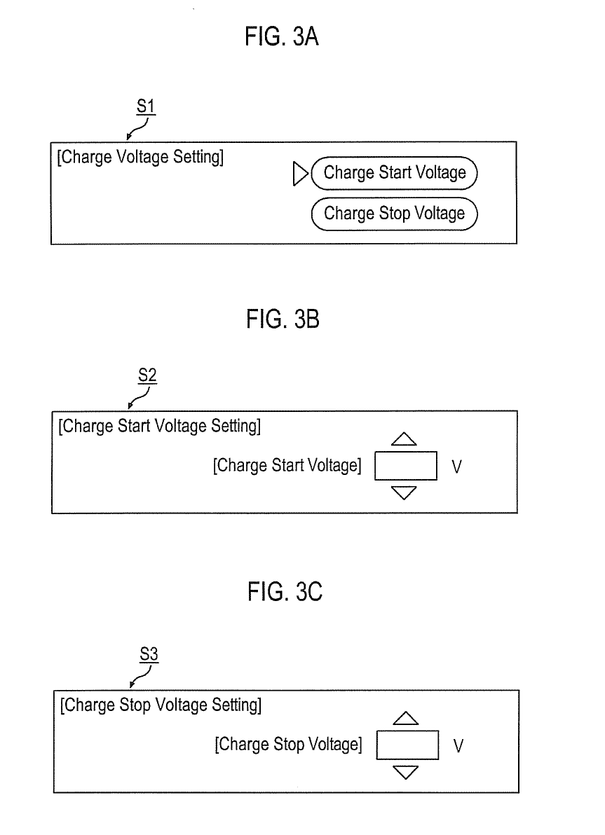

The input unit 34 includes the keyboard 15 and a keyboard controller. The input unit 34 controls a key input from the push buttons (e.g., the power button, the sheet feed button, the pause button, the mode selection button, and a switching button) of the keyboard 15. The display unit 35 includes the display 16, for example, a liquid crystal display (LCD), and a display controller. The display unit 35 controls the display of screens, for example, charge voltage setting screens (See FIGS. 3A to 3C) to be displayed on the display 16.

Referring FIGS. 3A to 3C, the charge voltage setting screens to be displayed on the display 16 in accordance with one embodiment are shown.

A setting screen S1 shown in FIG. 3A is a menu screen displayed on the display 16 when the mode selection button of the keyboard 15 is pushed by a user. The setting screen S1 includes selection items of, for example, a charge start voltage item and a charge stop voltage item. Each item may be selectable by the user for setting a charge start voltage or a charge stop voltage with respect to the storage battery 42 mounted in the main body housing 10.

A setting screen S2 shown in FIG. 3B is a charge start voltage setting screen having a display section that displays a charge start voltage to be set by the user. The setting screen S2 may be switched from the setting screen S1 and displayed on the display 16 to allow the user to set the charge start voltage. Such operation may be initiated by selecting the charge start voltage item of the setting screen S1, e.g., by the user pushing one of the push buttons on the keyboard 15. The charge start voltage is a voltage triggering a charge operation of the storage battery 42.

A setting screen S3 shown in FIG. 3C is a charge stop voltage setting screen having a display section that displays a charge stop voltage to be set by the user. The setting screen S3 may be switched from the setting screen S1 and displayed on the display 16 for allowing the user to set the charge stop voltage. Such operation is initiated by selecting the charge stop voltage item of the setting screen S1, e.g., by the user pushing one of the push buttons on the keyboard 15. The charge stop voltage is a voltage which once it is reached, suspends the charge operation of the storage battery 42.

Referring back to FIG. 2, the printing unit 36 includes the thermal head and a head driver. The printing unit 36 controls the heat generation of a heat-emitting element (not shown) of the thermal head under the control of the head driver, to thereby print information on the print surface of the label L.

The detection unit 37 includes a sensor and a sensor controller. The detection unit 37 processes a detection signal inputted from the sensor including a cover opening-closing sensor.

The conveying unit 38 includes the platen roller, the motor, and a motor driver. The conveying unit 38 is configured to withdraw and convey the leading end of the label L attached to the backing sheet M from the paper roll contained in the containing cavity.

The wireless communication interface 39 may be a communication interface for communicating with the external apparatus OM in compliance with a wireless telecommunication standard, for example, a wireless LAN. The wired communication interface 40 may be a communication interface for communicating with the external apparatus OM in compliance with a wired telecommunication standard, for example, USB.

The electric power control apparatus 41 converts electric power from the storage battery 42 inserted and mounted in the battery accommodation cavity 17 to supply the converted electric power to the CPU 30 and the components. Also, the power control apparatus 41 converts electric power from the external power source OP connected to the adapter terminal 19 through the adapter AD, to thereby supply the converted electric power to the CPU 30 and the components.

The storage battery 42 is detachable from the main body housing 10 and the connection portion thereof. The storage battery 42 is a battery serving as an internal electric power source of the portable printer 1. For example, the storage battery 42 may be a secondary battery that is rechargeable within a predetermined number of charge cycles, for example, several hundred cycles. Also, in some embodiments, a lithium-ion battery may be adopted as the storage battery 42.

FIG. 4 is a block diagram showing a detailed configuration of the electric power control apparatus 41 in accordance with one embodiment.

As shown in FIG. 4, the electric power control apparatus 41 includes a control circuit 401, a charge circuit 402, a switch 403, an electric power source detection circuit 404, and a voltage detection circuit 405.

The control circuit 401 includes a CPU 401a, a ROM 401b, and a RAM 401c. The control circuit 401 controls the commencing and suspending of a charge operation of the storage battery 42 in the charge circuit 402 based upon an output voltage of the storage battery 42 from the voltage detection circuit 405. The control circuit 401 also controls the turning on/off of the switch 403. The control circuit 401 is further configured to acquire the output voltage of the storage battery 42 from the voltage detecting circuit 405.

The CPU 401a deploys a program stored in the ROM 401b to the RAM 401c and executes the deployed program, and may control the entire operation of the electric power control apparatus 41.

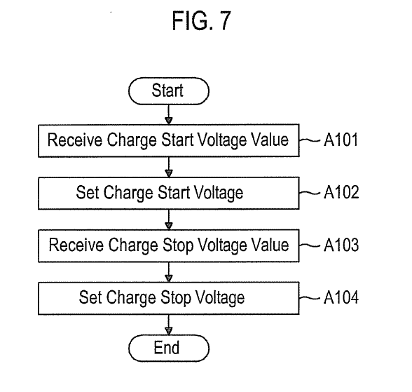

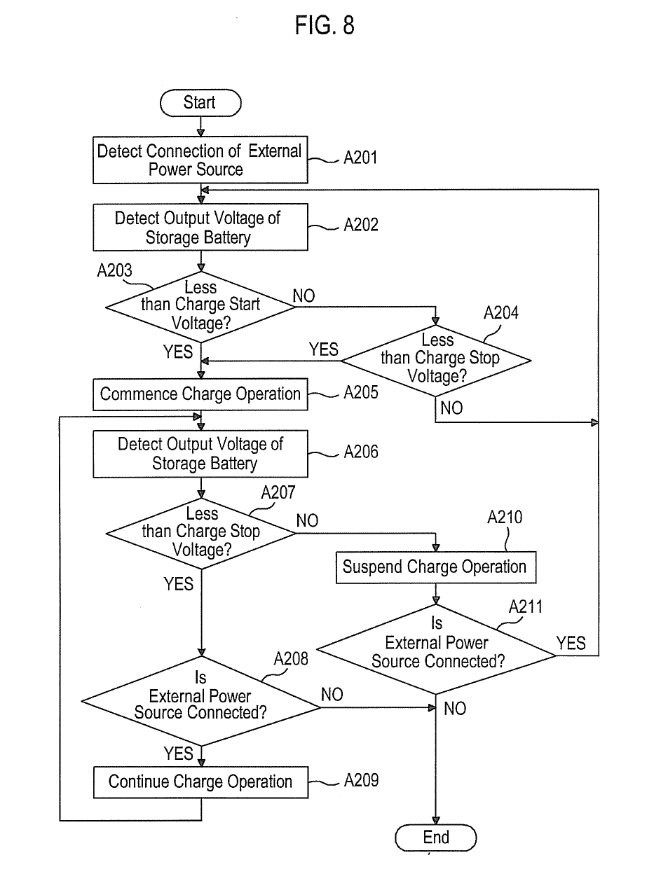

The ROM 401b stores programs for performing an electric power control, and files of data to be used in executing the programs. For example, in some embodiments, the ROM 401b may store programs for executing procedures to set a charge voltage, as shown in FIG. 7, and control the charging of a battery shown in FIG. 8. The RAM 401c also stores temporarily data during execution of the programs. For example, the RAM 401c may temporarily store data while the procedures are executed as shown in FIGS. 7 and 8.

The charge circuit 402 is configured to charge the storage battery 42 by using the electric power supplied from the external power source OP through the adapter AD, e.g., the cigarette lighter adapter under the control of the control circuit 401.

For example, if an output voltage of the storage battery 42 is lower than a charge start voltage and a charge start signal is received from the control circuit 401 while being powered from the external power source OP, the charge circuit 402 supplies a current to the storage battery 42 until the output voltage of the storage battery 42 reaches the charge stop voltage. In this case, the current supplied to the storage battery 42 flows in a direction opposite to a current applied during the discharge operation of the storage battery 42. On the other hand, if a discharge voltage of the storage battery 42 reaches the charge stop voltage and a charge stop signal is received from the control circuit 401, the charge circuit 402 suspends supplying the current to the storage battery 42.

The switch 403 is turned on or off according to an ON/OFF control signal from the control circuit 401 when the power button of the keyboard 15 is pushed. In this way, the switch 403 switches the supplying and blocking of the electric power from the external power source or the storage battery 42 for a load unit.

The electric power source detection circuit 404 detects whether the electric power is supplied from the external power source OP through the adapter AD or not and whether the storage battery 42 is mounted or not, to thereby output an electric power source detection signal to the control circuit 401.

The voltage detection circuit 405 converts an analog voltage outputted from the storage battery 42 into a digital voltage signal. The voltage detection circuit 405 outputs the digital voltage signal as an output voltage signal to the control circuit 401.

In the electric power control apparatus 41, the electric power is fed from the storage battery 42 mounted in the main body housing 10 or the external power source OP connected through the adapter AD. The electric power is supplied to the load unit, e.g., such as a drive line of the motor. Also, the electric power may be converted into a control voltage in a DC-DC (Direct Current) convertor to be supplied to the control circuit 401.

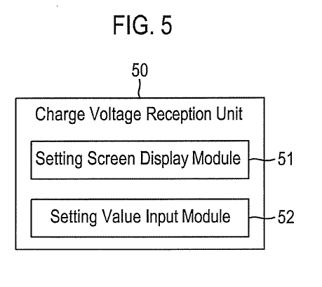

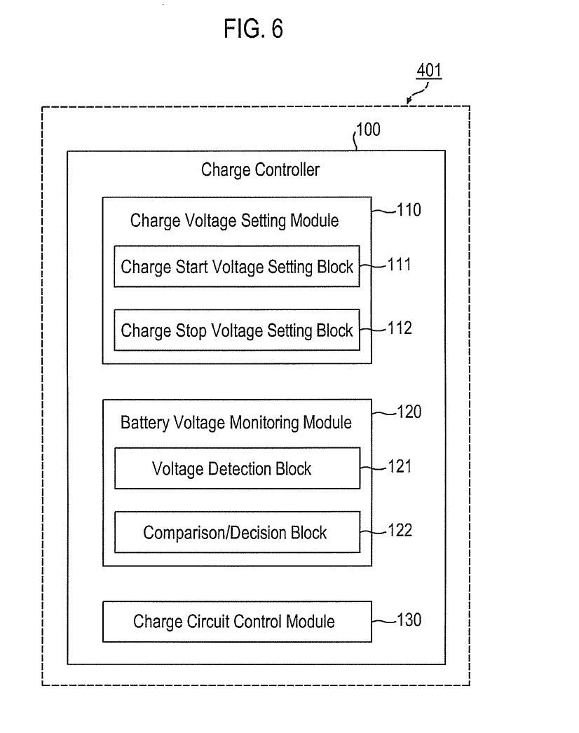

FIGS. 5 and 6 show functional configurations of the portable printer 1 in accordance with one embodiment.

As shown in FIG. 5, the portable printer 1 includes a charge voltage reception unit 50 for executing the procedures as shown in FIG. 7 which will be described later. The charge voltage reception unit 50 may have some functions to be executable in a micro computer including the CPU 30, the ROM 31, and the RAM 32.

The charge voltage reception unit 50 includes a setting screen display module 51 and a setting value input module 52. In response to a user's button manipulation, the setting screen display module 51 displays the setting screens S1 to S3 (as shown in FIG. 3) on the display 16. Also, in response to a user's button manipulation, the setting value input module 52 generates a charge start voltage and a charge stop voltage that have been set by the user on the setting screens S1 to S3, thereby outputting the generated voltages to a charge controller 100.

Further, the charge voltage reception unit 50 is configured to allow the user to set the charge start voltage and the charge stop voltage within an available capacity range of the storage battery 42 used in the portable printer 1. For example, the charge voltage reception unit 50 is configured to allow the user to set a voltage as the charge stop voltage to be less than a voltage of the fully-charged state of the storage battery 42 used in the portable printer 1. Hereinafter, the voltage of the fully-charged state is referred to as a fully-charged voltage. The charge start voltage may be greater than zero V (Volt). The charge voltage reception unit 50, for example, receives a charge start voltage greater than an operation warranty voltage of the portable printer 1 in which the storage battery 42 is mounted.

If an available capacity range, a fully-charged voltage, and an operation warranty voltage of the storage battery 42 are 0 V to 8.6 V, 8.4 V, and 7.0 V, respectively, the charge voltage reception unit 50 receives a charge stop voltage lower than the fully-charged voltage of 8.4 V. Also, the charge voltage reception unit 50 receives a charge start voltage greater than 7.0 V (for example, 8.0 V).

As shown in FIG. 6, the control circuit 401 includes the charge controller 100 for executing the procedures shown in FIGS. 7 and 8 which will be described later. The charge controller 100 may have a functional configuration that can be realized in a micro computer including the CPU 401a, the ROM 401b, and the RAM 401c.

The charge controller 100 includes a charge voltage setting module 110, a battery voltage monitoring module 120, and a charge circuit control module 130. The charge voltage setting module 110 sets charge start/stop voltages of the storage battery 42. The battery voltage monitoring module 120 monitors the output voltage of the storage battery 42. The charge circuit control module 130 controls commencing and suspending of the charge operation of the storage battery 42 in the charge circuit 402.

The charge voltage setting module 110 includes a charge start voltage setting block 111 and a charge stop voltage setting block 112. The charge start voltage setting block 111 is configured to set a start voltage for commencing the charge operation of the storage battery 42. Hereinafter, the start voltage for commencing the charge operation is referred to as the charge start voltage. The charge stop voltage setting block 112 is configured to set a stop voltage for suspending the charge operation of the storage battery 42. Hereinafter, the stop voltage for suspending the charge operation is referred to as the charge stop voltage.

The battery voltage monitoring module 120 includes a voltage detection block 121 and a comparison/decision block 122. The voltage detection block 121 detects the output voltage of the storage battery 42 based on the output voltage signal inputted from the voltage detection circuit 405. The comparison/decision block 122 compares the detected output voltage from the voltage detection block 121 with the charge start voltage set by the charge start voltage setting block 111 and the charge stop voltage set by the charge stop voltage setting block 112. Thereafter, the comparison/decision block 122 determines a control state, where either one of a charge start operation, charge hold operation, charge continuation operation, or charge stop operation is required, based on the comparison result, thereby sending the determined control state to the charge circuit control module 130.

In response to the determined control state from the comparison/decision block 122, the charge circuit control module 130 outputs to the charge circuit 402 a charge start signal for commencing the charge operation of the storage battery 42. Also, the charge circuit control module 130, responsive to the control state from the comparison/decision block 122, outputs to the charge circuit 402 a charge stop signal for suspending the charge operation of the storage battery 42.

Hereinafter, the operation of the control circuit 402 is described.

FIG. 7 illustrates a flow chart showing the procedures of setting the charge start voltage and the charge stop operation to be executed in the portable printer 1.

As shown in FIG. 7, the charge start voltage setting block 111 of the charge controller 100 in the control circuit 401 receives a charge start voltage value inputted according to the user's manipulation of the mode selection button on the keyboard 15 (Act A101). Further, the charge start voltage setting block 111 of the charge controller 100 sets the charge start voltage according to the inputted value (Act A102).

For example, during Acts A101 and A102, the setting screen display module 51 displays the setting screen S2 on the display 16. Further, the setting value input module 52 temporarily stores the charge start voltage set through the setting screen S2 in a memory area of the RAM 32. Concurrently, the setting value input module 52 outputs the charge start voltage to the charge controller 100 through the bus line BL. In this way, the charge start voltage setting block 111 acquires the charge start voltage to temporarily store it in a memory area of the RAM 401c.

Afterwards, the charge stop voltage setting block 112 receives a charge stop voltage value (Act A103) to set the charge stop voltage according to the received value (Act A104).

For example, during Acts A103 and A104, the setting screen display module 51 displays the setting screen S3 on the display 16. Further, the setting value input module 52 temporarily stores the charge stop voltage set through the setting screen S3 in a memory area of the RAM 32. Concurrently, the setting value input module 52 outputs the charge stop voltage to the charge controller 100 through the bus line BL. In this way, the charge stop voltage setting block 112 acquires the charge stop voltage to temporarily store it in a memory area of the RAM 401c.

Although the procedures shown in FIG. 7 are sequentially performed in the order of executing the charge start voltage reception/setting and then executing the charge stop voltage reception/setting, in some embodiments these procedures may be reversible.

Referring to FIG. 8, a flow chart illustrating the procedures of controlling the charge operation to be executed in the portable printer 1 is shown. During the procedures shown in FIG. 8, the storage battery 42 may be normally mounted in the body housing 10 and the connection portion thereof.

As shown in FIG. 8, the charge controller 100 of the control circuit 401 detects that the external power source OP is connected to the portable printer 1 (Act A201). If the external power source OP is connected to the portable printer 1, the battery voltage monitoring module 120 monitors a current charge state of the storage battery 42 to determine whether the portable printer 1 is powered ON or OFF (Acts A202 to A204).

For example, the voltage detection block 121 of the battery voltage monitoring module 120 detects an output voltage of the storage battery 42 mounted in the portable printer 1 (Act A202).

Thereafter, during Acts A203 and A204, the comparison/decision block 122 of the battery voltage monitoring module 120 compares the output voltage detected in Act A202 with the charge start voltage set through the charge start voltage setting block 111 and the charge stop voltage set through the charge stop voltage setting block 112. Further, the comparison/decision block 122 decides whether to commence the charge operation of the storage battery 42 or hold the charge operation.

If it is determined that the output voltage is less than the charge start voltage (YES of Act A203), or the output voltage is greater than the charge start voltage and less than the charge stop voltage (NO of Act A203 and YES of A204), i.e., if it is determined to commence the charge operation, the charge circuit control module 130 outputs a charge start signal for commencing the charge operation to the charge circuit 402 (Act A205). Therefore, in response to the charge start signal, the charge circuit 402 commences the charge operation of the storage battery 42.

During Acts A203 and A204, if it is determined that the output voltage is greater than the charge start voltage and the charge stop voltage (NO of Act A203 and NO of Act A204), i.e., if it is determined not to commence the charge operation, the procedure returns to Act A202 to proceed to the above mentioned procedures.

After Act A205, the charge controller 100 monitors the current charge state of the storage battery 42 as well as the connection state of the external power source OP during Acts A206 to A208.

For example, in Act A206, the voltage detection block 121 detects the output voltage of the storage battery 42 through the same procedure in Act A202.

Afterwards, through the same procedure in Act A204, the comparison/decision block 122 compares the output voltage detected in Act A206 with the charge stop voltage to decide whether to continue the charge operation of the storage battery 42 or suspend the charge operation thereof based on the comparison result (Act A207).

In this procedure, if it is determined that the output voltage is less than the charge stop voltage, i.e., if it is determined to continue the charge operation (YES of Act A207), the charge controller 100 decides whether the external power source OP is currently connected (Act A208). If it is determined that the external power source OP is currently connected (YES of Act A208), the charge controller 100 continues the charge operation (Act A209). That is, during this procedure, the charge circuit control module 130 does not output a charge stop signal to allow the charge circuit 402 to continue the charge operation of the storage battery 42.

Otherwise, if it is determined that the external electrical power source OP is not currently connected (NO of Act A208), the procedure is terminated.

Also, during Act A207, if it is determined that the output voltage is greater than the charge stop voltage (NO of Act A207), i.e., if it is determined to suspend the charge operation, the charge circuit control module 130 outputs a charge stop signal to the charge circuit 402 (Act A210). Therefore, in response to the charge stop signal, the charge circuit 402 suspends the charge operation of the storage battery 42.

Thereafter, the charge controller 100 decides whether the external power source OP is currently connected or not, through the same procedure in Act A208 (Act A211). If it is determined that the external power source OP is currently connected (YES of Act A211), the procedure returns to Act A202 to perform the above mentioned procedures regardless of the power ON or OFF of the portable printer 1. Otherwise, if it is determined that the external power source OP is currently disconnected (NO of Act A211), the procedure is terminated.

Also, according to the procedures shown in FIG. 8 (e.g., from NO of Act A203 to YES of Act A204), the charge operation of the storage battery 42 is normally performed even though the charge start voltage is set greater than the charge stop voltage due to a setting failure by the user.

If the user is notified of an error notice because of a setting failure, the portable printer 1 may not be operated due to a capacity loss of the storage battery 42. However, according to the above mentioned procedures of the present disclosure, the portable printer 1 may be normally operated regardless of the setting failure by the user.

In accordance with embodiments of the present disclosure, when the external power source OP is connected and the output voltage (e.g., the discharge voltage) of the storage battery 42 is greater than the charge start voltage set by the user, the charge operation of the storage battery 42 is not commenced. Therefore, the unnecessary increase in the number of actual charge cycles may be restrained to thereby prevent capacity degradation of the storage battery 42 and extend the life of the battery.

Moreover, in accordance with embodiments of the present disclosure, upon being powered from the external power source OP, the charge operation of the storage battery 42 is continued to make the output voltage (e.g., the discharge voltage) of the storage battery to reach the charge stop voltage set by the user, which is less than the fully-charged voltage of the storage battery 42, such that the charge operation of the storage battery 42 is suspended. Therefore, the fully-charged voltage of the storage battery 42 may not be reached, which restrains the capacity degradation of the storage battery 42 and extends the life of the battery.

While illustrative embodiments of the present disclosure are described, these embodiments are presented by way of example only, and not limited thereto.

For example, in the illustrative embodiments, the user may change and set the charge start voltage and the charge stop voltage within the capacity range of the storage battery 42. In addition, for example, depending upon a type of the storage battery 42 adopted in the portable printer 1, a charge start voltage and a charge stop voltage suitable for extending the life of the storage battery 42 may be fixed in advance.

Furthermore, a capacity range of a storage battery mounted in the portable printer 1 may be decided in accordance with the above mentioned procedures such that a charge start voltage and a charge stop voltage suitable for extending the life of the storage battery may be automatically calculated and set.

Although in the above mentioned embodiments, the user may appropriately set the charge start voltage and the charge stop voltage regardless of which voltage is greater than the other voltage, for example, the charge start voltage may be set not to exceed the charge stop voltage by the user.

Moreover, in accordance with the above mentioned embodiments, the user may set both of the charge start voltage and the charge stop voltage. In addition, for example, the user may set only one of the charge start voltage and the charge stop voltage.

According to the above mentioned embodiments, the electric power control apparatus 41 or the control circuit 401 may be mounted in an electronic machine such as the portable printer 1. However, in lieu of the portable printer 1, any type of electronic machine may be employed to install the electric power control apparatus 41 or the control circuit 401.

In the above mentioned embodiments, the electric power control apparatus 41 may separately include the voltage detection circuit 405 in addition to the control circuit 401. On the contrary, for example, the functions of the voltage detection circuit 405 may be implemented by the control circuit 401.

Also, in some embodiments a lithium-ion battery may be adopted as the storage battery 42, but not limited thereto.

In some embodiments the programs executed in the portable printer 1 may be stored in a memory device such as ROM or a computer-readable storage medium. Further, the programs executed on the portable printer 1 may be provided or distributed through a network, for example, an internet.

While the hardware and functional configurations of the portable printer 1, the electric power control apparatus 41, and the control unit 401, and the setting screens S1 to S3 are described in the above embodiments, these embodiments are presented by way of example only, and not limited thereto.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS (Operating System) or the like in the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the sprit of the inventions. The accompanying claims and their equivalents are intended to cover such forms or modifications as would fall within the scope and sprit of the inventions.

What is claimed is:

1. An electric power control apparatus mountable in an electronic machine for controlling a charge operation of a storage battery mounted on the electronic machine, the electric power control apparatus comprising:
a setting unit configured to set a voltage value in association with whether to perform a charge operation on the storage battery;
a voltage detection unit configured to detect an output voltage value of the storage battery; and
a control unit, upon being connected to an external power source, configured to control a charging unit to perform the charge operation if the detected output voltage value is lower than the voltage value, and suspend the charge operation if the detected output voltage value is greater than or equal to the voltage value.

2. The apparatus of claim 1, wherein the voltage value is a charge start voltage value for commencing the charge operation, and
the control unit, upon being connected to the external power source, to control the charging unit to commence the charge operation if the detected output voltage value is lower than the charge start voltage value, and suspend the charging operation if the detected output voltage value is greater than or equal to the charge start voltage value.

3. The apparatus of claim 2, wherein the setting unit is further configured to set a charge stop voltage value for suspending the charge operation, and
the control unit, upon being connected to the external power source, is configured to control the charging circuit to commence the charging operation if the detected output voltage value is less than the charge start voltage value and less than the charge stop voltage value, continue the charge operation until the detected output voltage value reaches the charge stop voltage value after the charge operation is commenced, and suspend the charge operation if the detected output voltage value has reached the charge stop voltage value.

4. The apparatus of claim 1, wherein the voltage value is a charge stop voltage value for suspending the charge operation, and
the control unit, upon being connected to the external power source, is configured to control the charging unit to perform the charge operation if the detected output voltage value is less than the charge stop voltage value, and suspend the charge operation if the detected output voltage value has reached the charge stop voltage value.

5. The apparatus of claim 1, further comprising a storage battery configured to be charged under the control of the electric power control apparatus.

6. A method for controlling a charge operation of a storage battery mounted on an electronic machine, the method comprising:
setting through a setting unit, a voltage value in association with whether to perform the charge operation of the storage battery;
detecting through a voltage detecting unit, an output voltage value of the storage battery; and
controlling through a control unit, upon being connected to an external power source, a charging unit to perform the charge operation if the detected output voltage value is lower than the voltage value, and suspend the charge operation if the detected output voltage value is greater than or equal to the voltage value.

7. The method of claim 6, wherein the voltage value is a charge start voltage value for commencing the charge operation, and
wherein controlling includes controlling through the control unit, upon being connected to the external power source, the charging unit to commence the charge operation if the detected output voltage value is lower than the charge start voltage value, and suspend the charging operation if the detected output voltage value is greater than or equal to the charge start voltage value.

8. The method of claim 7, wherein setting a voltage value further includes setting a charge stop voltage value for suspending the charge operation, and
wherein controlling includes controlling through the control unit, upon being connected to the external power source, the charging circuit to commence the charging operation if the detected output voltage value is less than the charge start voltage value and less than the charge stop voltage value, continue the charge operation until the detected output voltage value reaches the charge stop voltage value after the charge operation is commenced, and suspend the charge operation if the detected output voltage value has reached the charge stop voltage value.

9. The method of claim 6, wherein the voltage value is a charge stop voltage value for suspending the charge operation, and
wherein controlling includes controlling through the control unit, upon being connected to the external power source, the charging unit to perform the charge operation if the detected output voltage value is less than the charge stop voltage value, and suspend the charge operation if the detected output voltage value has reached the charge stop voltage value.

10. A printer, comprising:
a printing unit configured to print information on a printing medium;
a setting unit configured to set a voltage value in association with whether to perform a charge operation of a storage battery mountable in the printer;
a voltage detection unit configured to detect an output voltage value of the storage battery; and
a control unit, upon being connected to an external power source, configured to control a charging unit to perform the charge operation if the detected output voltage value is lower than the voltage value, and suspend the charge operation if the detected output voltage value is greater than or equal to the voltage value.

11. The printer of claim 10, wherein the voltage value is a charge start voltage value for commencing the charge operation, and
the control unit, upon being connected to the external power source, to control the charging unit to commence the charge operation if the detected output voltage value is lower than the charge start voltage value, and suspend the charging operation if the detected output voltage value is greater than or equal to the charge start voltage value.

12. The printer of claim 11, wherein the setting unit is further configured to set a charge stop voltage value for suspending the charge operation, and
the control unit, upon being connected to the external power source, to control the charging circuit to commence the charging operation if the detected output voltage value is less than the charge start voltage value and less than the charge stop voltage value, continue the charge operation until the detected output voltage value reaches the charge stop voltage value after the charge operation is commenced, and suspend the charge operation if the detected output voltage value has reached the charge stop voltage value.

13. The printer of claim 10, wherein the voltage value is a charge stop voltage value for suspending the charge operation, and
the control unit, upon being connected to the external power source, configured to control the charging unit to perform the charge operation if the detected output voltage value is less than the charge stop voltage value, and suspend the charge operation if the detected output voltage value has reached the charge stop voltage value.

14. The printer of claim 10, further comprising a storage battery configured to be charged under the control of the control unit.

15. The printer of claim 10, wherein the setting unit includes a keyboard, and
wherein the keyboard is arranged on an outer surface of a housing.
